(19) United States
(12) Patent Application Publication
(10) Pub. No.: US 2013/0029221 A1
(43) Pub. Date: Jan. 31, 2013

(54) ELECTRODE FOR AN ALKALINE ACCUMULATOR

(71) Applicants: Patrick BERNARD, Bordeaux (FR); Lionel GOUBAULT, Carigan De Bordeaux (FR); Stephane GILLOT, Ambares (FR)

(72) Inventors: Patrick BERNARD, Bordeaux (FR); Lionel GOUBAULT, Carigan De Bordeaux (FR); Stephane GILLOT, Ambares (FR)

(73) Assignee: SAFT, Bagnolet (FR)

(21) Appl. No.: 13/560,661

(22) Filed: Jul. 27, 2012

(30) Foreign Application Priority Data
Jul. 29, 2011 (FR) 11 56 956

(51) Int. Cl. H01M 4/48; H01M 4/38; H01M 4/64; B05D 5/12

(52) U.S. Cl. 429/211; 427/126.3; 252/521.2; 252/518.1; 252/519.33; 252/519.32; 252/512; 252/513

(57) ABSTRACT

The invention relates to a composition for electrodes comprising a material M selected from a nickel-based hydroxide and a hydrogen-fixing alloy, and a pentavalent niobium oxide Nb₂O₅ of monoclinic structure. The invention also proposes a positive electrode for an alkaline accumulator and a negative electrode for a nickel-metal hydride accumulator comprising the composition according to the invention as well as an alkaline accumulator comprising at least one electrode according to the invention.

### TECHNICAL FIELD

The technical field of the invention is that of alkaline accumulators notably that of accumulators of the nickel-metal hydride (NiMH), nickel-cadmium (NiCd), nickel-zinc (NiZn), nickel-hydrogen (NiH₂) and nickel-iron (NiFe) type.

### STATE OF THE ART

An alkaline accumulator generally comprises at least one positive electrode (cathode) and at least one negative electrode (anode). The positive electrode is separated from the negative electrode by a separator which generally consists of a polyolefin or a polyamide. The electrochemical bundle formed by the whole of the positive and negative electrodes and of the separators is impregnated with an electrolyte which is generally a solution of a strong base such as NaOH, LiOH or KOH.

Non-sintered (pasted) positive nickel electrodes used in alkaline accumulators generally consist of a three-dimensional conducting substrate such as nickel foam or a two-dimensional conducting substrate of the sheet type, of spherical nickel-hydroxide particles and of an electron-conducting cobalt compound, of the cobalt oxide or hydroxide type introduced as a powder or deposited at the surface of the nickel hydroxide particles. These conducting cobalt compounds notably give the possibility of ensuring good electronic contact between the nickel hydroxide particles which are not very conducting in the discharged condition, and the substrate.

A drawback of these positive electrodes in alkaline accumulators is the formation of micro-short-circuits. In the positive nickel electrode, the cobalt compounds of the hydroxide or oxide type, for which the degree of oxidation of the cobalt is 2.0, are soluble in the electrolyte. After a first complete charging of the accumulator, the cobalt compound is oxidized to a degree of oxidation greater than or equal to 3, generally cobalt oxyhydroxide is formed and is not very soluble in the electrolyte. During use, when the cycling temperature of the accumulator is high, cobalt oxyhydroxide may dissolve and when the voltage of the element becomes less than or equal to 1V, the cobalt oxyhydroxide may be reduced into a cobalt compound of the cobalt hydroxide type, soluble in the electrolyte. Accordingly, this conducting cobalt compound may migrate in the separator and form micro-short-circuits between the positive electrode and the negative electrode. When the short-circuit current is sufficiently large or when the cycling current is sufficiently small, these micro-short-circuits generate a loss of capacity of the accumulator.

An NiMH accumulator belongs to the family of alkaline accumulators and typically comprises at least one positive electrode comprising an active material mainly consisting of a hydroxide based on nickel, at least one negative electrode mainly consisting of a metal capable of reversibly inserting hydrogen in order to form a hydride. During use in storage, cycling or floating of an NiMH accumulator, the hydrogen-fixing alloy present in the negative electrode corrodes in an aqueous medium forming hydroxides or oxides, notably hydroxides of transition metals Co, Mn or Al which are soluble in the electrolyte and which may therefore migrate and be deposited in the separator or in the positive electrode. Deposited in the separator, the cobalt-based compound which is conducting, also causes the formation of micro-short-circuits which contribute to additional loss of capacity of the accumulator.

Document EP-A-1 168 471 describes a positive electrode for an alkaline accumulator, in which the composition for the positive electrode comprises a nickel hydroxide, cobalt oxide containing sodium and a niobium-based compound.

The objective of the present invention is to reduce the loss of capacity in cycling due to the formation of micro-short-circuits in an alkaline accumulator.

### SUMMARY OF THE INVENTION

For this purpose, the present invention proposes a composition for electrodes comprising a material M selected from a nickel-based hydroxide and a hydrogen-fixing alloy and niobium oxide Nb₂O₅ with a monoclinic structure.

According to an embodiment, the composition for electrodes comprises from 0.1 to 3% by mass of niobium oxide Nb₂O₅ with a monoclinic structure, based on the mass of the material M, preferably from 0.1 to 0.5% by mass of niobium oxide Nb₂O₅ with a monoclinic structure.

According to an embodiment, the composition for electrodes further comprises niobium oxide Nb₂O₅ with an orthorhombic structure in such a proportion that the mass of niobium oxide Nb₂O₅ accounts for at most 3% of the mass of the material M.

According to an embodiment, the composition for electrodes is such that the niobium oxide with a monoclinic structure accounts for 50 to 90% by mass of the monoclinic niobium oxide and of the orthorhombic niobium oxide.

According to an embodiment, the composition for electrodes comprises from 0.1 to 2.9% by mass of niobium oxide Nb₂O₅ with a monoclinic structure and from 0.1 to 2.9% by mass of niobium oxide Nb₂O₅ with an orthorhombic structure based on the mass of the material M, preferably from 0.1 to 0.5% by mass of each niobium oxide Nb₂O₅.

According to an embodiment, the niobium oxide of the composition for electrodes essentially consists of niobium oxide with a monoclinic structure or of niobium oxide with a monoclinic structure and of niobium oxide with an orthorhombic structure.

According to an embodiment of the invention, the material M for a positive electrode is a nickel-based hydroxide.

By <<nickel-based hydroxide>> is meant a nickel hydroxide, a hydroxide mainly containing nickel, but also a nickel hydroxide containing at least one syncristallized hydroxide of an element selected from zinc (Zn), cadmium (Cd), magnesium (Mg) and aluminium (Al), and at least one syncristallized hydroxide of an element selected from cobalt (Co), manganese (Mn), aluminium (Al), yttrium (Y), calcium (Ca), zirconium (Zr), copper (Cu). A syncristallized hydroxide contained in nickel hydroxide is a hydroxide forming a solid solution with nickel hydroxide, i.e. occupying in a continuously variable proportion, the atomic sites defined by the crystalline lattice of the nickel hydroxide. The nickel hydroxide may preferably be covered with a coating based on possibly partly oxidized cobalt hydroxide.

According to an embodiment, the composition for the positive electrode further comprises at least one thickener such as carboxymethylcellulose (CMC), hydroxyethylcellulose (HEC), hydroxypropyl-methylcellulose (HPMC), hydroxypropylcellulose (HPC), poly(acrylic acid) (PAAc), xanthan gum, guar gum poly(ethylene oxide) (PEO) or a mixture thereof.

According to an embodiment, the composition for a positive electrode further comprises at least one binder such as a copolymer of styrene and butadiene (SBR) optionally carboxylated, a copolymer of acrylonitrile and butadiene (NBR), a copolymer of styrene, ethylene, butylene and styrene (SEBS), a terpolymer of styrene, butadiene and vinlypyridine (SBVR), polyamide (PA), polyethylene (PE), a copolymer of the ethylene-vinyl acetate type (EVA), a copolymer of silane, a polymer with an acrylate function of the polyacrylate, styrene-acrylate, styrene-maleic anhydride type, polytetrafluorethylene (PTFE), a fluorinated copolymer of ethylene and propylene (FEP), polyhexafluoropropylene (PHFP), and perfluoromethyl vinyl ether (PMVE) or a mixture thereof.

According to an embodiment, the composition for a positive electrode further comprises at least one compound selected from cobalt oxides and cobalt hydroxides, such as CoO, Co(OH)₂, LiₓCoO₂ (with 0.1≦x≦1), NaₓCoO₂ (with 0.1≦x ≦1), HₓCoO₂ (with 0.1≦x≦1), CoₓO₄ (with 2.5≦x≦3).

According to an embodiment, the composition for electrodes further comprises at least one compound selected from nickel, cobalt or carbon.

According to an embodiment, the composition for a positive electrode further comprises at least one compound selected from zinc oxides and hydroxides such as ZnO or Zn(OH)₂, yttrium oxides and hydroxides such as Y₂O₃ or Y(OH)₃, ytterbium oxides and hydroxides such as Yb₂O₃ or Yb(OH)₃ and calcium oxides, hydroxides and fluorinated derivatives such as CaO, Ca(OH)₂ or CaF₂ or a mixture thereof.

According to an embodiment of the invention, the material M for a negative electrode is a hydrogen-fixing alloy of formula ABx wherein:

A is an element selected from La, Ce, Nd, Pr, Mg, Sm, Y or a mixture thereof,

B is an element selected from Ni, Mn, Fe, Al, Co, Cu, Zr, Sn or a mixture thereof,

x is a number such as 3≦x≦6.

According to an embodiment, the alloy is selected from the group comprising alloys of the AB₅, A₅B₁₉ and A₂B₇ type, or a mixture thereof.

According to an embodiment, the composition for a negative electrode further comprises at least one thickener such as carboxymethylcellulose (CMC), hydroxypropylmethylcellulose (HPMC), poly(acrylic acid) (PAAc) and poly(ethylene oxide) (PEO) or a mixture thereof.

According to an embodiment, the composition for a negative electrode further comprises at least one binder such as a copolymer of butadiene-styrene (SBR), polystyrene acrylate (PSA) and polytetrafluorethylene (PTFE), or a mixture thereof.

According to an embodiment, the composition for a negative electrode further comprises at least one compound selected from nickel as a powder, carbon as a powder or fibers, carbon nanotubes.

According to an embodiment, the composition for a positive and/or negative electrode further comprises fibers of at least one polymer, such as polyamide, polypropylene, polyethylene or a mixture thereof.

The invention also proposes a positive electrode comprising the composition for a positive electrode previously described and a current collector.

The invention also proposes a negative electrode comprising the composition for negative electrode previously described and a current collector.

The invention proposes an alkaline accumulator comprising at least one positive electrode according to the invention.

The invention also proposes an alkaline accumulator comprising at least one negative electrode according to the invention.

According to an embodiment, the alkaline accumulator comprises at least one positive electrode according to the invention and at least one negative electrode according to the invention.

The invention also proposes a method for making an electrode according to the invention comprising the steps:
a) providing a material M, the material M being selected from a nickel-based hydroxide, a hydrogen-fixing alloy;
b) providing a niobium oxide Nb₂O₅ with a monoclinic structure;
c) preparing an aqueous mixture comprising the material M and the niobium oxide with a monoclinic structure in order to obtain a paste;
d) depositing the paste obtained in step c) on a current collector.

According to an embodiment, with the manufacturing method, the positive electrode according to the invention may be obtained,

According to an embodiment, with the manufacturing method, the negative electrode according to the invention may be obtained.

The invention also proposes a method for improving the life-time of an accumulator, comprising a step for incorporating niobium oxide Nb₂O₅ with a monoclinic structure to a material M, the material M being selected from a nickel-based hydroxide, a hydrogen-fixing alloy.

The methods of the invention are advantageously applied according to one or several of the alternatives described above and detailed below for making the composition for electrodes.

An advantage of the invention is the limitation of the formation of micro-short-circuits in alkaline accumulators.

Another advantage of the invention is improving the life-time of NiCd and NiMH accumulators which are intended for applications of the emergency lighting type (Emergency Lighting Unit (ELU)) for which the charging process of the accumulators is slow, typically at a charging current of the order of Cn/20, wherein

Cn is the rated capacity of the element, and the temperature of the accumulators is high, generally above 40° C.

Other features and advantages of the invention will become apparent upon reading the description which follows of a preferred embodiment of the invention, given as an example.

### SHORT DESCRIPTION OF THE FIGURES

FIG. 1 shows an X ray diffraction diagram of a monoclinic niobium Nb₂O₅ oxide powder.

FIG. 2 shows an X ray diffraction diagram of an orthorhombic Nb₂O₅ niobium oxide powder.

FIG. 3 shows a X ray diffraction diagram of a positive electrode comprising 0.5% of monoclinic Nb₂O₅ niobium oxide.

FIG. 4 shows an X ray diffraction diagram of a positive electrode comprising 0.5% of orthorhombic Nb₂O₅ niobium oxide.

### DISCUSSION OF THE EMBODIMENTS OF THE INVENTION.

According to the invention, the composition for electrodes for an alkaline accumulator comprises a material M, further called an active material or electrochemically active material, and a pentavalent niobium oxide Nb₂O₅ with a monoclinic crystalline structure.

The monoclinic niobium oxide (designated as m-Nb₂O₅) may be present in a proportion such that its mass is comprised between 0.1% and 3% of the M compound mass, preferably such that its mass represents from 0.1 to 0.5% of the M compound mass.

The monoclinic pentavalent niobium oxide may be used in combination with the pentavalent niobium oxide Nb₂O₅ with an orthorhombic crystalline structure (designated as o-Nb₂O₅). Each niobium oxide accounts for 0.1 to 2.9% of the M material mass, preferably for 0.1 to 0.5% of the total M material mass. The material M may comprise at most 3% of monoclinic and orthorhombic Nb₂O₅ niobium oxide.

According to an embodiment of the invention, the composition for electrodes is such that the niobium oxide with a monoclinic structure accounts for 50 to 90% by mass of the monoclinic niobium oxide and of the orthorhombic niobium oxide.

According to an embodiment of the invention, the niobium oxide present in the composition essentially consists of niobium oxide with a monoclinic structure and niobium oxide with an orthorhombic structure.

Surprisingly it was seen that by incorporating niobium oxide Nb₂O₅ with a monoclinic structure to the material M, it is possible to reduce the short circuits. Niobium oxide with a crystalline structure is obtained commercially, for example through the retailer Acros Organics.

The crystalline forms may be detected by analyzing an X ray diffraction diagram. The crystalline form of each niobium oxide was characterized by X ray diffraction (XRD) by means of a Bruker D5000 θ-2θ diffractometer (Bragg-Brentano geometry, Cu Kα radiation, 2θ angular range=5 to 90°, step 0.03°). Identification of the phases was carried out by comparison with JCPDS (Joint Committee on Powder Diffraction Standards) sheets. The references of JCPDS sheets are 00-037-1468 for monoclinic niobium oxide and 01-071-0336 for orthorhombic niobium oxide.

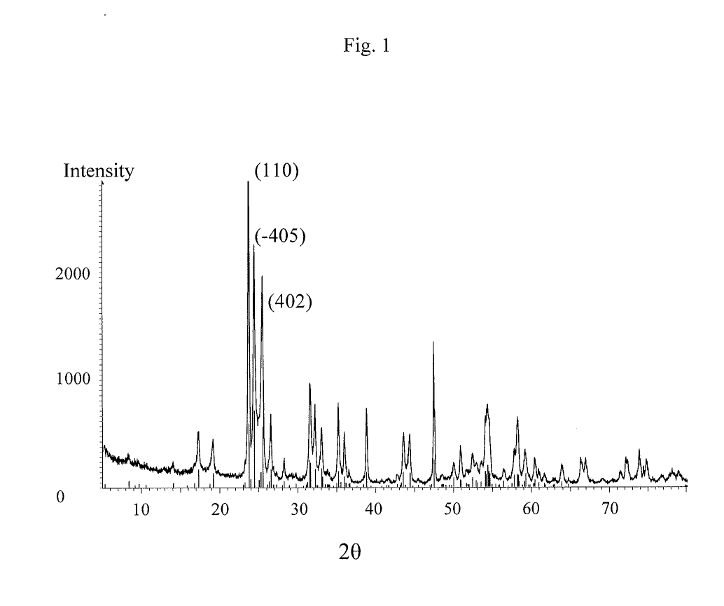

The monoclinic niobium oxide belonging to the space group P2(3) is defined by the lattice parameters a, b, c and β such that a=20.381; b=3.82490; c=19.3680, a/b=5.32851 and β=115.69°. The index of the hkl planes (110), (−405) and (402) is indicated in FIG. 1 for the three most intense lines.

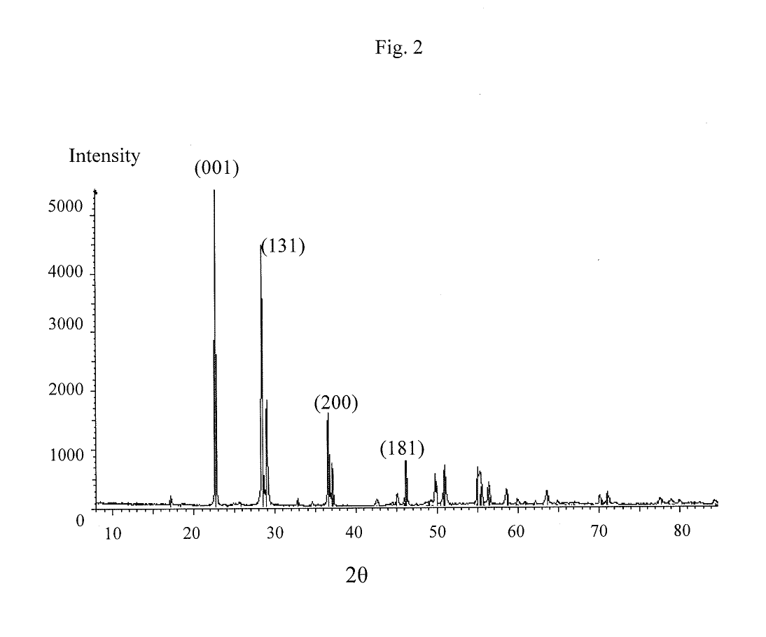

The orthorhombic niobium oxide belonging to the space group Pbam(55) is defined by the lattice parameters a, b and c such that a=6.17500; b=29.1750; c=3.9300 and a/b=0.21165. The index of the hkl planes (001), (131), (200) and (181) is indicated in FIG. 2 for the four most intense lines.

The monoclinic niobium oxide and the orthorhombic niobium oxide are easily distinguished by their most intense lines in the X ray diffraction diagram, d(110)=3.74538Å, d(−405)=3.64245Å, d(402)=3.48895Å for the monoclinic form (FIG. 1) and d(001)=3.93000Å, d(131)=3.14013Å, d(200)=3.08750Å, d(181)=2.45321Å for the orthorhombic form (FIG. 2).

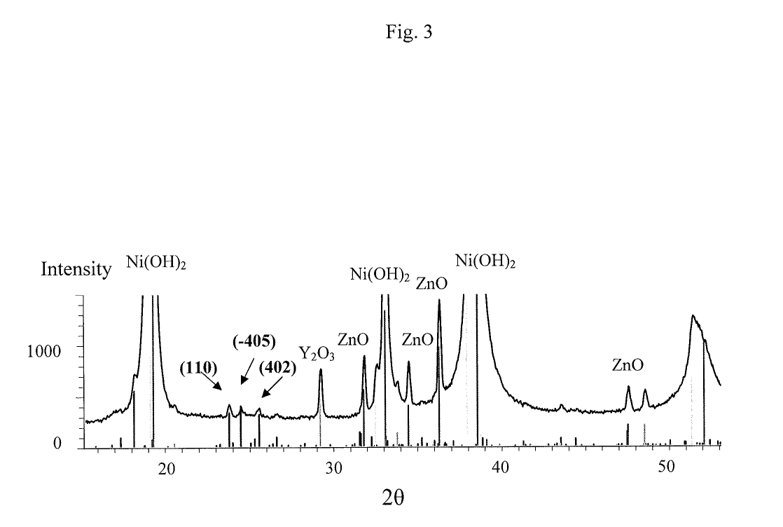

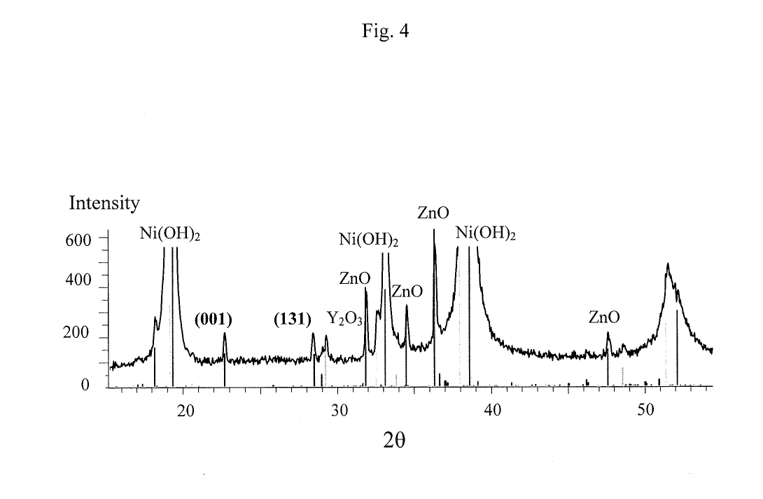

Within the M material composition for electrodes, its presence may be detected by X ray diffraction. In FIG. 3, it is possible to identify the monoclinic niobium oxide by the presence of the planes (110), (−405) and (402). In FIG. 4, orthorhombic niobium oxide may be identified by the presence of the planes (001) and (131).

The invention also relates to a positive electrode comprising said M material composition.

The material M for a positive electrode is a nickel-based hydroxide. By <<nickel-based hydroxide>> is meant a nickel hydroxide, a hydroxide mainly containing nickel, but also a nickel hydroxide containing at least one syncrystallized hydroxide of an element selected from zinc (Zn), cadmium (Cd), magnesium (Mg) and aluminium (Al), and at least one syncrystallized hydroxide of an element selected from cobalt (Co), manganese (Mn), aluminium (Al), yttrium (Y), calcium (Ca), zirconium (Zr), copper (Cu). A syncrystallized hydroxide contained in nickel hydroxide is a hydroxide forming a solid solution with nickel hydroxide, i.e. occupying in a continuously variable proportion, the atomic sites defined by the crystalline lattice of nickel hydroxide. The nickel hydroxide may preferably be covered with a coating based on possibly partly oxidized cobalt hydroxide.

Advantageously, the size of the particles of the nickel based hydroxide is characterized by a Dv 50% comprised between 5 and 15 μm.

The M material composition for a positive electrode may optionally comprise one or several additional additives, intended to facilitate application and the performances of the electrode. Among the additives, mention may be, without this list being exhaustive, made of:

thickeners such as carboxymethylcellulose (CMC), hydroxyethylcellulose (HEC), hydroxypropyl-methylcellulose (HPMC), hydroxypropylcellulose (HPC), poly(acrylic acid) (PAAc), xanthan gum, guar gum, poly(ethylene oxide) (PEO),

binders such as a copolymer of styrene and butadiene (SBR) optionally carboxylated, a copolymer of acrylonitrile and butadiene (NBR), a copolymer of styrene, butylene and styrene (SEBS), a terpolymer of styrene, butadiene and vinyl pyridine (SBVR), a polyamide (PA), a polyethylene (PE), a copolymer of the ethylene-vinyl acetate type (EVA), a copolymer of silane, a polymer with an acrylate function of the polyacrylate, styrene-acrylate, styrene-maleic anhydride type, polytetrafluoroethylene (PTFE), a fluorinated copolymer of ethylene and propylene (FEP), polyhexafluoropropylene (PPHF), and perfluoromethylvinylether (PMVE),

fibers of at least one polymer, such as polyamide, polypropylene, polyethylene, etc. for improving the mechanical properties of the electrode,

electron conducting agents selected for example from cobalt oxides and hydroxides such as for example CoO, Co(OH)₂, LiₓCoO₂ (0.1≦x≦1), NaₓCoO₂ (0.1≦x≦1), HₓCoO₂ (0.1≦x≦1), CoₓO₄ (2.5≦x≦3), or selected from a compound of the nickel, cobalt or carbon type,

other compounds selected from zinc compounds such as ZnO or Zn(OH)₂, yttrium compounds Y₂O₃, ytterbium compounds like Yb₂O₃ or Yb(OH)₃ and calcium compounds such as CaO, Ca(OH)₂ or CaF₂. Preferably, this compound is added in powdery form.

The positive electrode is made by pasting a current collector with a paste consisting of an aqueous mixture of the M material composition and of additives according to the invention, and by then drying the current collector containing said paste.

The material M and the additive according to the invention are added in a water dispersion at room temperature in order to obtain a paste. The paste typically comprises:
from 60 to 90% by mass of material M and of monoclinic niobium oxide Nb₂O₅ and optionally orthorhombic niobium oxide Nb₂O₅;
from 0 to 5% by mass of at least one binder;
from 0 to 4% by mass of at least one thickener;
from 0 to 30% by mass of at least one conducting agent;
from 15 to 30% by mass of water.

Drying is accomplished according to the general knowledge of one skilled in the art, for example in air at 80° C. for 2 h.

The current collector may be three-dimensional, as a foam or a felt, or two-dimensional, as a perforated or non-perforated sheet, of a deployed metal, of a grid or of a fabric. This current collector may be based on metal or carbon. Preferably, the current collector is in nickel or in nickel-plated steel.

The thickness of the electrode may be comprised between 0.2 and 2 mm.

The invention also proposes a negative electrode of the metal hydride type comprising said composition comprising the material M.

The material M for a negative electrode is a hydrogen-fixing alloy of formula ABₓ wherein:

A is an element selected from La, Ce, Nd, Pr, Mg, Sm,Y or a mixture thereof,

B is an element selected from Ni, Mn, Fe, Al, Co, Cu, Zr, Sn or a mixture thereof,

x is a number such that 3≦x ≦6.

Advantageously, the size of the hydrogen-fixing alloy particles is characterized by a Dᵥ 50% comprised between 20 and 200 μm, preferably between 30 and 100 μm.

Preferably, the alloy is selected from the group comprising alloys of the AB₅, A₅B₁₉ and A₂B₇ type or a mixture thereof.

The M material composition for a negative electrode may optionally comprise one or several additional additives, intended for facilitating the application and performances of the electrode. Among the additives, mention may be, without this list being exhaustive, made of:

thickeners such as carboxymethylcellulose (CMC), hydroxypropylmethylcellulose (HPMC), poly(acrylic acid) (PAAc), poly(ethylene oxide) (PEO),

binders such as butadiene-styrene copolymers (SBR), polystyrene acrylate (PSA), polytetrafluorethylene (PTFE),

fibers of at least one polymer, such as polyamide, polypropylene, polyethylene, etc., these fibers allowing improvement in the mechanical properties of the electrode,

conducting agents such as nickel powder, carbon powder or carbon fibers, carbon nanotubes.

The negative electrode is made by pasting a current collector with a paste consisting of an aqueous mixture of the M material composition and of additives according to the invention and by drying the current collector containing said paste.

The material M and the additives according to the invention are added into a water dispersion at room temperature in order to obtain a paste. The paste typically comprises:
from 60 to 90% by mass of material M and of monoclinic niobium oxide Nb₂O₅ and optionally orthorhombic niobium oxide Nb₂O₅;
from 0 to 5% by mass of at least one binder;
from 0 to 4% by mass of at least one thickener;
from 0 to 30% of a conducting agent;
from 15 to 30% of water.

Drying is accomplished according to the general knowledge of one skilled in the art, for example, for 2 h at 80° C. in air.

The current collector may be nickel foam, a planar or three-dimensional perforated plate in nickel or in nickel-plated steel.

The thickness of the electrode may be comprised between 0.2 and 2 mm.

Advantageously, the negative electrode is covered with a surface layer intended to improve discharge at a high rate and/or the recombination of oxygen at the end of charging.

The invention also proposes an accumulator with an alkaline electrolyte comprising at least one positive electrode according to the invention. This accumulator typically comprises at least one positive electrode according to the invention, at least one negative electrode, at least one separator and one alkaline electrolyte.

The negative electrode may be based on cadmium, zinc, iron, a hydrogen-fixing alloy or hydrogen.

The separator generally consists of fibers in polyolefin (for example in polypropylene) or in polyamide, is porous, non-woven.

The electrolyte is a concentrated alkaline aqueous solution comprising at least one hydroxide (KOH, NaOH, LiOH), in a concentration generally of the order of several times normality.

The pastes for electrodes are prepared in a standard way, the positive and negative pastes are deposited on the respective current collectors in order to form the positive and negative electrodes, and then at least one positive electrode, one separator and one negative electrode are superposed in order to form the electrochemical bundle. The electrochemical bundle is introduced into a container cup and it is impregnated with an aqueous alkaline electrolyte. The accumulator is then closed.

The invention relates to any format of accumulators : a prismatic format (planar electrodes) or cylindrical format (spiral-shaped or concentric electrodes). The accumulator according to the invention may be of the open type (open or half open) or of the sealed type.

The alkaline accumulator may be of the nickel-metal hydride, nickel-cadmium, nickel-iron, nickel-zinc or nickel-hydrogen type.

The invention also relates to an accumulator of the nickel-metal hydride type comprising at least one negative electrode according to the invention.

According to an embodiment, the alkaline accumulator of the nickel-metal hydride type comprises at least one negative electrode according to the invention and at least one positive electrode according to the invention.

### EXAMPLES

Sealed NiCd accumulators of standardized format AA with a rated capacity Cn of 800 mAh were made.

The positive electrodes were made as follows: a paste made up from an aqueous mixture of nickel-hydroxide, of monoclinic and/or orthorhombic niobium oxide Nb₂O₅, of CMC (thickener), an aqueous PTFE dispersion containing 40% of water (binder), cobalt hydroxide (conductor), yttrium oxide and zinc oxide is pasted in a nickel foam of a porosity of about 95%. The powdery material M consists of a nickel-based hydroxide. The monoclinic and/or orthorhombic niobium oxide Nb₂O₅ (from the supplier Acros Organics) is added as a powder to the dispersion used for preparing the paste. The proportions of each of the niobium oxides based on the mass of the material M in the positive electrode are noted in Table 1. The proportions of each of the materials in the aqueous paste are the following:

Ni(OH)₂+Niobium oxides: 67%

Co(OH)₂: 6%

ZnO: 2%

Y₂O₃: 0.4%

CMC: 0.4%

PTFE dispersion: 1.2%

Once the paste is deposited on the current collector, the whole is dried in air at 80° C. for 2 hours in order to remove the water, laminated and cut out so as to obtain the electrodes with the desired dimensions. All the positive electrodes are cut out to the same dimensions.

The negative electrodes were made as follows: a paste consisting of an aqueous powder mixture of CdO, HPMC (thickener), SBR (binder), is pasted in a nickel foam. All the negative electrodes are cut to the same dimensions.

The bundle consisting of the positive electrode, of the separator and of the negative electrode is spiral-shaped and introduced into the cup. The connecting elements are then assembled. The cup is filled with a ternary 8.5N electrolyte consisting of KOH, NaOH and LiOH.

These accumulators with a format AA are first of all subject to 1 cycle (charging for 3 h at 20 mA, charging for 3 h at 264 mA, discharge at 160 mA at the final voltage of 1.0V) and then to 2 cycles (charging for 16 h at 80 mA, at rest for 1 h, discharge at 160 mA at the final voltage of 1.0V). The capacity of the accumulators in cycle 3, expressed in mAh and as a percentage of the rated capacity, is noted in Table 1. These accumulators of format AA are then subject to extended cycling at 40° C. consisting of charging for 24 h at 40 mA, of discharge at 160 mA at the final voltage of 1.0V. The cycling is stopped when the capacity of the accumulator becomes less than or equal to 75% of the rated capacity. The number of cycles required for obtaining a capacity of less than or equal to 75% of the rated capacity is indicated in Table 1.

The accumulators ‘b’, ‘c’ and ‘d’ are examples of accumulators according to the invention and the accumulators ‘a’ and ‘e’ are comparative examples which do not belong to the invention.

TABLE 1
Table grouping the obtained results

| | Accumulator | | | | | |
|---|---|---|---|---|---|---|
| | a | b | c | d | e | f |
| m-Nb₂O₅ mass/M | 0 | 0.25 | 0.5 | 4 | 0 | 0.25 |
| material mass (%) | | | | | | |
| o-Nb₂O₅ mass/M | 0 | 0 | 0 | 0 | 0.25 | 0.25 |
| material mass M (%) | | | | | | |
| Capacity at cycle 3 | 803 | 800 | 794 | 755 | 800 | 794 |
| (mAh) | | | | | | |
| Capacity at cycle 3 | 100 | 100 | 99 | 94 | 100 | 99 |
| (% Cn) | | | | | | |
| Number of cycles for | 41 | 108 | 151 | 125 | 52 | 164 |
| obtaining C ≦ 0.75Cn | | | | | | |

Examination of Table 1 shows that the cycling capacity at 40° C. of the accumulators between ‘a’ and ‘e’ which do not contain any monoclinic niobium Nb₂O₅ becomes less than 75% of the rated capacity after only 41 cycles (accumulator ‘a’) or 52 cycles (accumulator ‘e’).

The initial capacities of the accumulators ‘b’, ‘c’, ‘e’, ‘f’ are comprised between 99 and 100% of the rated capacity while the accumulator ‘d’ for which the mass of monoclinic niobium oxide is equal to 4%, has a reduced capacity of 755 mAh i.e. 94% of the rated capacity in the initial state.

The accumulators ‘b’, ‘c’, ‘d’, the positive electrode of which contains monoclinic niobium oxide Nb₂O₅, retain a cycling capacity at 40° C. of greater than 75% of the rated capacity for more than 108 cycles, i.e. a gain in the number of cycles of more than 100% as compared with accumulators which do not contain any monoclinic niobium oxide. On the other hand, the accumulator ‘f’, the positive electrode of which contains a mixture of monoclinic niobium oxide Nb₂O₅ and of orthorhombic niobium oxide retains a cycling capacity at 40° C. of more than 75% of the rated capacity for 164 cycles.

It is seen that at an equal content of pentavalent niobium oxide, adding into the positive electrode, a mixture of orthorhombic and monoclinic niobium oxides is more efficient than adding niobium oxide exclusively with the monoclinic structure.

Moreover, adding into the positive electrode, an orthorhombic niobium oxide (accumulator ‘e’) is less efficient than adding a monoclinic niobium oxide (accumulator ‘b’).

Thus, the accumulators ‘b’, ‘c’ and ‘f’ according to the invention have an initial capacity greater than or equal to 99% of the rated capacity and retain a capacity greater than 75% of the rated capacity for more than 108 cycles at 40° C. (charging for 24 h at 40 mA, discharge at 160 mA at the final voltage of 1V) unlike the accumulators ‘a’ and ‘e’ the composition of which comprising the material M of the positive electrode is outside the scope of the invention.

1. A composition for electrodes comprising:
a) a material M selected from a nickel-based hydroxide, a hydrogen-fixing alloy;
b) niobium oxide Nb₂O₅ with a monoclinic structure.

2. The composition for electrodes according to claim 1, comprising from 0.1 to 3% by mass of niobium oxide Nb₂O₅ with a monoclinic structure, based on the mass of the material M, preferably from 0.1 to 0.5% by mass.

3. The composition for electrodes according to claim 1, further comprising niobium oxide Nb₂O₅ with an orthorhombic structure in a proportion such that the mass of niobium oxide Nb₂O₅ accounts for at most 3% of the mass of the material M.

4. The composition for electrodes according to claim 3, wherein the niobium oxide Nb₂O₅ with a monoclinic structure accounts for 50 to 90% by mass of the niobium oxide with monoclinic structure and of the niobium oxide with orthorhombic structure.

5. The composition for electrodes according to claim 1, comprising from 0.1 to 2.9% by mass of niobium oxide Nb₂O₅ with monoclinic structure and from 0.1 to 2.9% by mass of niobium oxide Nb₂O₅ with orthorhombic structure, preferably from 0.1 to 0.5% mass of each niobium oxide Nb₂O₅.

6. The composition for electrodes according to claim 1, further comprising fibers of at least one polymer such as polyamide, polypropylene, polyethylene or a mixture thereof.

7. The composition for electrodes according to claim 1, wherein the material M is a nickel-based hydroxide.

8. The composition for electrodes according to claim 7, further comprising at least one thickener such as carboxymethylcellulose (CMC), hydroxyethylcellulose (HEC), hydroxypropyl-methylcellulose (HPMC), hydroxypropylcellulose (HPC), poly(acrylic acid) (PAAc), xanthan gum, guar gum, poly(ethylene oxide) (PEO) or a mixture thereof.

9. The composition for electrodes according to claim 7, further comprising at least one binder such as a copolymer of styrene and of butadiene (SBR), optionally carboxylated, a copolymer of acrylonitrile and of butadiene (NBR), a copolymer of styrene, ethylene, butylene and styrene (SEBS), a terpolymer of styrene, butadiene and vinyl pyridine (SBVR), polyamide (PA), polyethylene (PE), a copolymer of the ethylene-vinyl acetate type (EVA), a copolymer of silane, a polymer with an acrylate function of the polyacrylate, styrene-acrylate, styrene-maleic anhydride type, polytetrafluoroethylene (PTFE), a fluorinated copolymer of ethylene and of propylene (FEP), polyhexafluoropropylene (PHFP), and perfluoromethylvinylether (PMVE) or a mixture thereof.

10. The composition for electrodes according to claim 7, further comprising at least one compound selected from cobalt oxides and cobalt hydroxides such as CoO, Co(OH)₂, LiₓCoO₂ with 0.1≦x≦1, NaₓCoO₂ with 0.1≦x≦1, HₓCoO₂ with 0.1≦x≦1, CoₓO₄ with 2.5≦x≦3.

11. The composition for electrodes according to claim 7, further comprising at least one compound selected from nickel, cobalt or carbon.

12. The composition for electrodes according to claim 7, further comprising at least one compound selected from zinc oxide and hydroxides such as ZnO or Zn(OH)₂, yttrium oxides and hydroxides such as Y₂O₃ or Y(OH)₃, ytterbium oxides and hydroxides such as Yb₂O₃ or Yb(OH)₃, and calcium oxides, hydroxides and fluorinated derivatives of calcium, such as CaO, Ca(OH)₂ or CaF₂ or a mixture thereof.

13. The composition for electrodes according to claim 1, wherein the material M is a hydrogen-fixing alloy of formula ABₓ wherein:
A is an element selected from La, Ce, Nd, Pr, Mg, Sm, Y or a mixture thereof,
B is an element selected from Ni, Mn, Fe, Al, Co, Cu, Zr, Sn or a mixture thereof,
x is a number such that 3≦x≦6.

14. The composition for electrodes according to claim 13, wherein the alloy is selected from the group comprising the alloys of type AB₅, A₅B₁₉ and A₂B₇, or a mixture thereof.

15. The composition for electrodes according to claim 13, further comprising at least one thickener such as carboxymethylcellulose (CMC), hydroxypropylmethylcellulose (HPMC), poly(acrylic acid) (PAAc) and poly(ethylene oxide) (PEO) or a mixture thereof.

16. The composition for electrodes according to claim 13, further comprising at least one binder such as a butadiene-styrene copolymer (SBR), polystyrene acrylate (PSA) and polytetrafluoroethylene (PTFE) or a mixture thereof.

17. The composition for electrodes according to claim 13, further comprising at least one compound selected from nickel as a powder, carbon as a powder or fibers, carbon nanotubes.

18. A positive electrode comprising:
a) a composition for electrodes comprising a nickel-based hydroxide and niobium oxide Nb₂O₅ with a monoclinic structure;
b) a current collector.

19. A negative electrode comprising:
a) a composition for electrodes comprising:
i) a hydrogen-fixing alloy of formula ABx wherein:
A is an element selected from La, Ce, Nd, Pr, Mg, Sm, Y or a mixture thereof,
B is an element selected from Ni, Mn, Fe, Al, Co, Cu, Zr, Sn or a mixture thereof,
x is a number such that 3≦x≦6;
ii) niobium oxide Nb₂O₅ with a monoclinic structure;
b) a current collector.

20. An alkaline accumulator comprising at least one positive electrode, said positive electrode comprising:
a) a composition for electrodes comprising a nickel-based hydroxide and niobium oxide Nb₂O₅ with a monoclinic structure;
b) a current collector.

21. An alkaline accumulator comprising at least one negative electrode, said negative electrode comprising:
a) a composition for electrodes comprising:
i) a hydrogen-fixing alloy of formula ABx wherein:
A is an element selected from La, Ce, Nd, Pr, Mg, Sm, Y or a mixture thereof,
B is an element selected from Ni, Mn, Fe, Al, Co, Cu, Zr, Sn or a mixture thereof,
x is a number such that 3≦x≦6;
ii) niobium oxide Nb₂O₅ with a monoclinic structure;
b) a current collector.

22. An alkaline accumulator wherein at least one positive electrode is according to claim 18 and at least one negative electrode is according to claim 19.

23. A method for manufacturing an electrode comprising the steps:
a) providing a material M, the material M being selected from a nickel-based hydroxide, a hydrogen-fixing alloy;
b) providing a niobium oxide Nb₂O₅ with a monoclinic structure;
c) preparing an aqueous mixture comprising the material M and the niobium oxide with monoclinic structure in order to obtain a paste;
d) depositing the paste obtained in step c) on a current collector.
